(19) United States
(12) Patent Application Publication
(10) Pub. No.: US 2023/0422317 A1
(43) Pub. Date: Dec. 28, 2023

(54) ESTIMATION DEVICE, NON-TRANSITORY COMPUTER READABLE STORAGE MEDIUM, AND ESTIMATION SYSTEM

(71) Applicant: KABUSHIKI KAISHA TOKAI RIKA DENKI SEISAKUSHO, Aichi (JP)

(72) Inventor: Yosuke HASEGAWA, Aichi (JP)

(73) Assignee: KABUSHIKI KAISHA TOKAI RIKA DENKI SEISAKUSHO, Aichi (JP)

(21) Appl. No.: 18/136,623

(22) Filed: Apr. 19, 2023

(30) Foreign Application Priority Data
Jun. 28, 2022 (JP) 2022-103739

(51) Int. Cl. H04W 76/10; H04B 17/27

(52) U.S. Cl. CPC H04W 76/10; H04B 17/27

(57) ABSTRACT

An estimation device comprising an estimation section configured to estimate a position of a second communication device on a basis of wireless communication between at least one first communication device and the second communication device, the wireless communication being compliant with a predetermined communication standard, wherein the predetermined communication standard is a standard in which communication including at least two communication stages is performed, the at least two communication stages including a first stage and a second stage, the first stage is a communication stage in which information for establishing the second stage is transmitted and received, the second stage is a communication stage that allows for more secure communication than communication in the first stage, and the estimation section estimates the position of the second communication device on a basis of a broadcast signal including encoding data, the broadcast signal being broadcast in the first stage.

### CROSS REFERENCE TO RELATED APPLICATION(S)

This application is based upon and claims benefit of priority from Japanese Patent Application No. 2022-103739, filed on Jun. 28, 2022, the entire contents of which are incorporated herein by reference.

### BACKGROUND

The present invention relates to an estimation device, a non-transitory computer readable storage medium, and an estimation system.

In recent years, technology has been developed that estimates the position of a device on the basis of wireless communication. For example, JP 2022-012634A discloses technology that estimates the position of a portable terminal on the basis of Bluetooth (registered trademark) Low Energy (BLE) communication between an onboard apparatus and the portable terminal

### SUMMARY

However, an apparatus that adopts a communication standard such as BLE sometimes has a limit to the number of devices that are simultaneously connectable to the apparatus through wireless communication compliant with the communication standard. The limit as described above is thus approached as a larger number of devices are connected to achieve the position estimation of the apparatus.

Accordingly, the present invention has been devised in view of the issue described above. The present invention achieves highly accurate position estimation of an apparatus while decreasing the number of devices simultaneously connected to the apparatus that is approaching the limit.

To solve the above described problem, according to an aspect of the present invention, there is provided an estimation device comprising an estimation section configured to estimate a position of a second communication device on a basis of wireless communication between at least one first communication device and the second communication device, the wireless communication being compliant with a predetermined communication standard, wherein the predetermined communication standard is a standard in which communication including at least two communication stages is performed, the at least two communication stages including a first stage and a second stage, the first stage is a communication stage in which information for establishing the second stage is transmitted and received, the second stage is a communication stage that allows for more secure communication than communication in the first stage, and the estimation section estimates the position of the second communication device on a basis of a broadcast signal including encoding data, the broadcast signal being broadcast by one of the first communication device or the second communication device in the first stage.

To solve the above described problem, according to another aspect of the present invention, there is provided a non-transitory computer readable storage medium having a program stored therein, the program causing a computer to achieve an estimation function of estimating a position of a second communication device on a basis of wireless communication between at least one first communication device and the second communication device, the wireless communication being compliant with a predetermined communication standard, wherein the predetermined communication standard is a standard in which communication including at least two communication stages is performed, the at least two communication stages including a first stage and a second stage, the first stage is a communication stage in which information for establishing the second stage is transmitted and received, the second stage is a communication stage that allows for more secure communication than communication in the first stage, and the program causes the estimation function to estimate the position of the second communication device on a basis of a broadcast signal including encoding data, the broadcast signal being broadcast by one of the first communication device or the second communication device in the first stage.

To solve the above described problem, according to another aspect of the present invention, there is provided an estimation system comprising: at least one first communication device; and an estimation device configured to estimate a position of a second communication device on a basis of wireless communication between the first communication device and the second communication device, the wireless communication being compliant with a predetermined communication standard, wherein the predetermined communication standard is a standard in which communication including at least two communication stages is performed, the at least two communication stages including a first stage and a second stage, the first stage is a communication stage in which information for establishing the second stage is transmitted and received, the second stage is a communication stage that allows for more secure communication than communication in the first stage, and the estimation device estimates the position of the second communication device on a basis of a broadcast signal including encoding data, the broadcast signal being broadcast by one of the first communication device or the second communication device in the first stage.

As described above, the present invention makes it possible to achieve highly accurate position estimation of an apparatus while decreasing the number of devices simultaneously connected to the apparatus that is approaching the limit.

### BRIEF DESCRIPTION OF THE DRAWINGS

FIG. 1 is a block diagram illustrating a configuration example of an estimation system 1 according an embodiment of the present invention.

FIG. 2 is a sequence diagram illustrating an example of a flow of authentication of a portable apparatus 20 according to the embodiment.

FIG. 3 is a sequence diagram illustrating an example of a flow of acquisition of information that is used for position estimation of a second communication device 210 according to the embodiment.

FIG. 4 is a sequence diagram illustrating an example of a flow of control over a control target device 130 based on the position estimation of the second communication device 210 according to the embodiment and a result of the position estimation.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

### 1.1. System Configuration Example

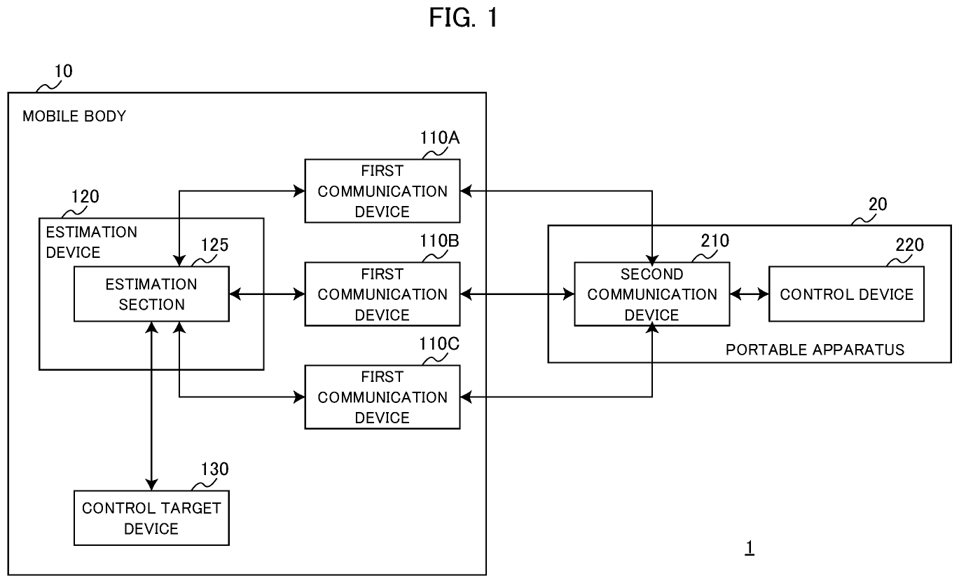

First, a configuration example of an estimation system 1 according an embodiment of the present invention will be described. FIG. 1 is a block diagram illustrating the configuration example of the estimation system 1 according to the present embodiment.

As illustrated in FIG. 1, an estimation system 1 according to the present embodiment may include a first communication device 110, an estimation device 120, a control target device 130, a second communication device 210, and a control device 220.

The first communication device 110, the estimation device 120, and the control target device 130 according to the present embodiment may be mounted, for example, on a mobile body 10 as illustrated in FIG. 1.

Meanwhile, the second communication device 210 and the control device 220 according to the present embodiment are mounted on a portable apparatus 20 different from the mobile body 10.

### (Mobile Body 10)

The mobile body 10 according to the present embodiment may be, for example, a vehicle such as a car, an aircraft, or a vessel.

### (First Communication Device 110)

The at least one or more first communication devices 110 according to the present embodiment are mounted on the mobile body 10. It should be noted that FIG. 1 exemplifies a case where the mobile body 10 is mounted with three first communication devices 110A to 110C.

In a case where the mobile body 10 is mounted with the plurality of first communication devices 110, the respective first communication devices 110 may be mounted at positions different from each other.

For example, in a case where the mobile body 10 is a car, the first communication devices 110A to 110C may be separately mounted near a driver's seat, a passenger seat, a rear seat, and the like.

Each of the first communication devices 110 according to the present embodiment performs wireless communication compliant with a predetermined communication standard with the second communication device 210 mounted on the portable apparatus 20.

The first communication device 110 according to the present embodiment therefore includes an antenna to transmit and receive a wireless signal compliant with the predetermined communication standard.

The wireless communication compliant with the predetermined communication standard between each of the first communication devices 110 and the second communication device 210 is used for the estimation device 120 to estimate the position (the position of the portable apparatus 20) of the second communication device 210.

In addition, one of the first communication devices 110 performs wireless communication with the second communication device 210 to authenticate the portable apparatus 20.

Here, the predetermined communication standard described above may be a standard in which communication including at least two communication stages is performed. The at least two communication stages include a first stage and a second stage.

For example, the first stage may be a communication stage in which information for establishing the second stage is transmitted and received. The second stage may be a communication stage that allows for more secure communication than communication in the first stage.

In addition, for example, the first stage and the second stage may use different frequency bands (channels) to perform wireless communication. Alternatively, information regarding a channel to be used for wireless communication in the second stage may be transmitted and received in the first stage.

In addition, for example, packets are exchanged at predetermined intervals in the second stage.

Examples of the predetermined communication standard described above include BLE.

In a case of BLE, the second stage may be a communication stage in which a connection state is established and a packet is transmitted and received between the devices. Meanwhile, the first stage is a stage preceding the second stage. The first stage may be a stage for broadcasting an advertisement, scanning an advertisement, and the like.

In addition, in the case of BLE, it is possible to encode only a portion of signals such as advertisements transmitted and received in the first stage. In contrast, it is possible to encode all signals transmitted and received in the second stage. The second stage may be therefore considered a communication stage that allows for more secure communication than communication in the first stage.

In addition, in the case of BLE, an advertising channel is used in the first stage and a data channel is used in the second stage. In addition, the advertising channel and the data channel are channels different from each other.

In addition, in the case of BLE, packets are exchanged at defined connection intervals in the second stage. It should be noted that an empty packet is transmitted in the second stage even in a case there is no data to be transmitted. In a case where the exchange of packets is stopped, the second stage is cancelled.

Meanwhile, the predetermined communication standard described above may be Wi-Fi (registered trademark) Direct.

In a case of Wi-Fi Direct, the first stage may be a communication stage for transmitting and scanning a beacon, performing an association process, performing an authentication process (4-way handshake or EAPoL), and the like. Meanwhile, the second stage may be a communication stage in which the first stage is completed, a connection is established between the devices, and a packet is transmitted and received.

In addition, in the case of Wi-Fi Direct, an association process, an authentication process, and the like are performed in the first stage and the second stage is then begun. The second stage may be therefore considered a communication stage that allows for more secure communication than communication in the first stage.

In addition, in the case of Wi-Fi Direct, a beacon that is transmitted and scanned in the first stage includes channel information.

In addition, in the case of Wi-Fi Direct, an access point updates a multicast key (GTK) and transmits a key update notification (EAPoL Group Key Message) to a station connected to the access point for each certain period in the second stage. Meanwhile, the station that receives the key update notification performs an appropriate key update process and transmits back a key update acceptance (EAPoL Group Key Message).

The predetermined communication standard has been described above with reference to the specific examples. It should be noted that the following describes, as a main example, a case where BLE is adopted as the predetermined communication standard described above.

### (Estimation Device 120)

The estimation device 120 according to the present embodiment includes an estimation section 125 that estimates the position of the second communication device 210 on the basis of wireless communication compliant with a predetermined communication standard between the at least one first communication device 110 and the second communication device 210.

The second communication device 210 according to the present embodiment is mounted on the portable apparatus 20. Therefore, the estimation section 125 may also be considered to estimate the position of the portable apparatus 20.

In addition, the estimation section 125 according to the present embodiment controls the control target device 130 on the basis of the estimated position of the second communication device 210 and a result of the authentication of the second communication device 210 based on wireless communication between one of the first communication devices 110 and the second communication device 210.

The estimation section 125 according to the present embodiment may cause the control target device 130 to execute a predetermined operation in a case where the estimation section 125 estimates that the second communication device 210 is positioned within a predetermined range and the authentication proves the authenticity of the portable apparatus 20.

Functions of the estimation section 125 according to the present embodiment are achieved by a variety of processors. Details of the functions of the estimation section 125 according to the present embodiment will be described below.

### (Control Target Device 130)

The control target device 130 according to the present embodiment may include a variety of devices that each perform a predetermined operation in accordance with the control of the estimation device 120.

In a case where the control target device 130 is mounted on the mobile body as illustrated in FIG. 1, the control target device 130 may be a locking and unlocking device that, for example, locks and unlocks a door included in the mobile body 10 as the predetermined operation.

For example, the estimation device 120 may cause the control target device 130 to unlock the door in a case where the estimation device 120 estimates that the second communication device 210 is positioned within a predetermined range from the mobile body 10 and the authentication proves the authenticity of the portable apparatus 20.

The control target device 130 and the predetermined operation are not, however, limited to the examples described above.

For example, the control target device 130 may be an engine. In this case, the predetermined operation may be permitting the engine to start or prohibiting the engine from starting.

In addition, for example, the control target device 130 may be a lighting device. In this case, the predetermined operation may be turning on or off the light.

### (Portable Apparatus 20)

The portable apparatus 20 according to the present embodiment is carried by a user (e.g., an owner of the mobile body 10, a person who is permitted by the owner to use the mobile body 10, or the like) of the mobile body 10.

It should be noted that, although not illustrated in FIG. 1, the portable apparatus 20 may be mounted with an input device that receives an operation made by the user, a display device that displays various kinds of information, or the like.

The portable apparatus 20 according to the present embodiment may include, for example, a smartphone, a tablet, a wearable device, and the like.

### (Second Communication Device 210)

The second communication device 210 according to the present embodiment performs wireless communication compliant with a predetermined communication standard with the at least one first communication device 110.

The second communication device 210 according to the present embodiment therefore includes an antenna to transmit and receive a wireless signal compliant with the predetermined communication standard.

### (Control Device 220)

The control device 220 according to the present embodiment collectively controls the respective devices mounted on the portable apparatus 20.

Functions of the control device 220 are achieved by a variety of processors.

The configuration example of the estimation system 1 according the present embodiment has been described above. It should be noted that the configuration described above with reference to FIG. 1 is merely an example. The configuration of the estimation system 1 according to the present embodiment is not limited to the example.

For example, the first communication device 110, the estimation device 120, and the control target device 130 do not necessarily have to be mounted on the mobile body 10.

In addition, a component different from the estimation device 120 may achieve a function of controlling the control target device 130 on the basis of a result of the position estimation of the second communication device 210 and a result of the authentication of the portable apparatus 20.

It is possible to flexibly modify the configuration of the estimation system 1 according to the present embodiment in accordance with the specifications and operations.

### 1.2. Authentication of Portable Apparatus 20

Next, the authentication of the portable apparatus 20 according to the present embodiment will be described in detail.

The portable apparatus 20 according to the present embodiment may be authenticated independently of the estimation of the position of the second communication device 210.

For example, the portable apparatus 20 according to the present embodiment may be authenticated before the estimation of the position of the second communication device 210.

In contrast, the authentication of the portable apparatus 20 according to the present embodiment may be begun after the estimation of the position of the second communication device 210.

Meanwhile, the portable apparatus 20 according to the present embodiment may be authenticated in parallel with the estimation of the position of the second communication device 210.

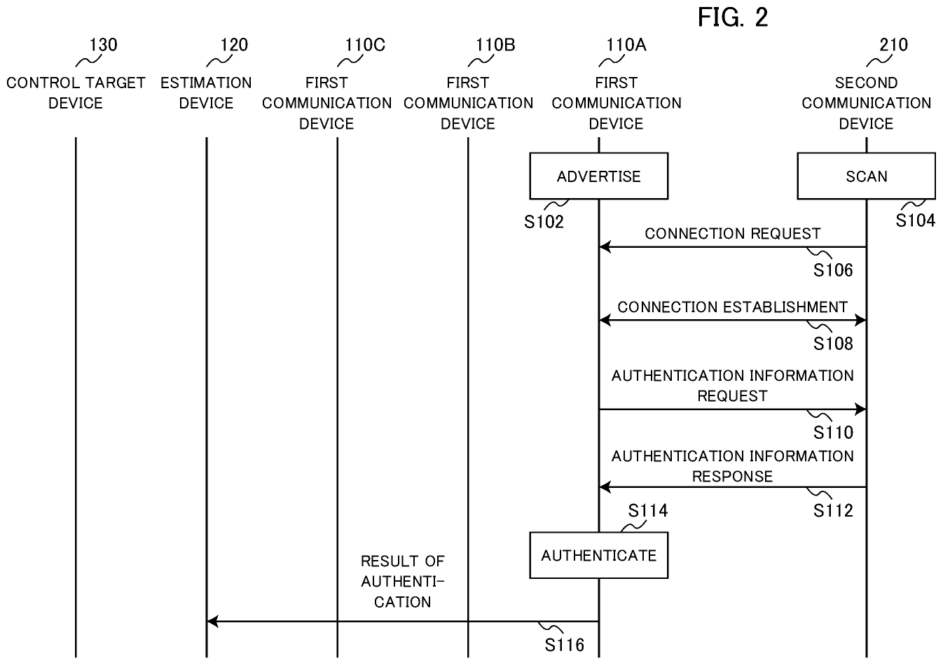

FIG. 2 is a sequence diagram illustrating an example of a flow of the authentication of the portable apparatus 20 according to the present embodiment.

It should be noted that FIG. 2 illustrates an example of a sequence in a case where the first communication device 110A authenticates the portable apparatus 20 in the configuration illustrated in FIG. 1.

In addition, FIG. 2 illustrates an example of a sequence in a case where BLE is adopted as the predetermined communication standard.

In the example illustrated in FIG. 2, the first communication device 110A first broadcasts an advertisement (S102).

Next, the second communication device 210 scans the advertisement broadcast in step S102 (S104).

In addition, the second communication device 210 transmits a connection request (CONNECT_IND) to the first communication device 110A on the basis of the advertisement scanned in step S104 (S106).

After transmitting a connection request in step S106, the second communication device 210 transitions to the connection state.

In addition, the first communication device 110A that receives the connection request in step S106 also transitions to the connection state. This establishes a connection between the first communication device 110A and the second communication device 210. In other words, the second stage described above is established (S108).

Once the second stage is established, the first communication device 110A transmits an authentication information request to the second communication device 210 (S110). By using the authentication information request, the first communication device 110A requests the second communication device 210 to transmit information (authentication information) necessary to authenticate the second communication device 210.

The authentication information may be, for example, an identifier of the second communication device 210, a password, a calculation result or the like. The calculation result is obtained by performing calculation from a random number included in the authentication information request, a predetermined function, and the like.

The second communication device 210 that receives the authentication information request in step S110 transmits back an authentication information response including the authentication information (S112).

The first communication device 110A that receives the authentication information response in step S112 authenticates the second communication device 210 on the basis of the authentication information included in the authentication information response (S114).

The first communication device 110A transmits a result of the authentication in step S114 to the estimation device 120 (S116).

The flow of the authentication of the portable apparatus 20 according to the present embodiment has been described above. It should be noted that the flow described above with reference to FIG. 2 is merely an example. The flow of the authentication of the portable apparatus 20 according to the present embodiment is not limited to the example.

For example, the case has been described above where the first communication device 110A broadcasts an advertisement and the second communication device 210 scans the advertisement.

In contrast, an advertisement may be broadcast by the second communication device 210 and scanned by the first communication device 110A.

In this case, it is sufficient if the first communication device 110A that scans the advertisement transmits a connection request to the second communication device 210.

In addition, for example, the case has been described above where the two signals of an authentication information request and an authentication information response are transmitted and received to achieve authentication.

A variety of sequences widely used in the authentication technology field are, however, applicable to authenticate the portable apparatus 20 according to the present embodiment.

It is possible to flexibly modify the authentication of the portable apparatus 20 according to the present embodiment in accordance with the specifications and operations.

### 1.3. Position Estimation of Second Communication Device 210

Next, the position estimation of the second communication device 210 according to the present embodiment will be described in detail.

As described above, in a case where another device is connected by using a certain communication standard, some communication standards impose limits to the number of simultaneously connectable devices.

However, a variety of devices have been gaining widespread use in recent years. It is a possible situation that a user requests a plurality of devices to be constantly connected to the portable apparatus 20.

For example, in a case where the portable apparatus 20 is a smartphone, the devices as described above include earphones, headphones, a wearable device, PC, a tablet, a keyboard, a display, a mouse, a game pad, and the like.

In a case where the second communication device 210 mounted on the portable apparatus 20 has already been connected to the plurality of devices as described above, the second communication device 210 may fail, in some situations, to be newly connected to the first communication device 110 that is used for the position estimation of the portable apparatus 20.

To achieve the position estimation of the second communication device 210 in the situation as described above, it is necessary to disconnect the second communication device 210 and a connected device and then newly connect the second communication device 210 and the first communication device 110.

In this case, as a larger number of first communication devices 110 are requested to be connected to the second communication device 210 for the position estimation of the second communication device 210, a smaller number of other devices are connectable to the second communication device 210. This may cause inconvenience to the user.

The technical idea according to the present embodiment has been conceived in view of the points as described above and achieves highly accurate position estimation of an apparatus while decreasing the number of devices simultaneously connected to the apparatus that is approaching the limit.

The estimation section 125 according to the present embodiment therefore has a feature that the estimation section 125 estimates the position of the second communication device 210 on the basis of a broadcast signal including encoding data. The broadcast signal is broadcast by one of the first communication device 110 or the second communication device 210 in the first stage.

In other words, the position estimation of the second communication device 210 according to the present embodiment is performed on the basis of a broadcast signal that is transmitted and received in the first stage preceding the second stage in which the first communication device 110 and the second communication device 210 are requested to be connected.

The position estimation method according to the present embodiment therefore makes it possible to achieve the position estimation of the portable apparatus 20 and maintain convenience without bringing the number of devices simultaneously connected to the second communication device 210 close to the limit.

In addition, the broadcast signal including the encoding data described above may be a signal that is the first to be transmitted and received in the first stage.

In this case, a broadcast signal transmitted by one of the first communication device 110 or the second communication device 210 is received by the other of the first communication device 110 or the second communication device 210. This causes another signal to be transmitted and received in the first stage.

The position estimation of the second communication device 210 is performed on the basis of the broadcast signal that is the first to be transmitted and received in the first stage. This makes it possible to complete the whole process earlier, expecting an effect of increasing responsiveness.

It should be noted that, in a case where the predetermined communication standard is BLE, the broadcast signal described above may be, for example, an advertisement (ADV_IND).

In addition, in a case where the broadcast signal described above is an advertisement (ADV_IND), the encoding data described above may be a resolvable private address.

The resolvable private address is a random address that is dynamically generated on the basis of a key (IRK: Identity Resolving Key) exchanged in pairing.

This allows the first communication device 110 or the second communication device 210 that receives the advertisement (ADV_IND) including the resolvable private address to verify the validity of the address by decoding the resolvable private address with the IRK exchanged in pairing.

It should be noted that, in a case where the mobile body 10 is mounted with the plurality of first communication devices 110, the plurality of first communication devices 110 may share IRK. For example, the first communication devices 110B and 110C may each decode a resolvable private address by using IRK exchanged by the first communication device 110A in pairing with the second communication device 210.

As described above, the estimation section 125 according to the present embodiment may estimate the position of the second communication device 210 on the basis of information calculated from the reception condition of the broadcast signal including the encoding data that is decodable.

The estimation technique as described above makes it possible to clarify a target for position estimation and achieve a more secure process.

It should be noted that the broadcast signal and the encoding data according to the present embodiment are not limited to the examples described above.

In a case where the predetermined communication standard is BLE, the broadcast signal according to the present embodiment may be, for example, an extended advertisement (ADV_EXT_IND).

The extended advertisement (ADV_EXT_IND) is a signal including a larger payload section than that of an advertisement (ADV_IND). It is also possible to put encoding data in the payload section.

The following describes a flow of the position estimation according to the present embodiment with reference to an example.

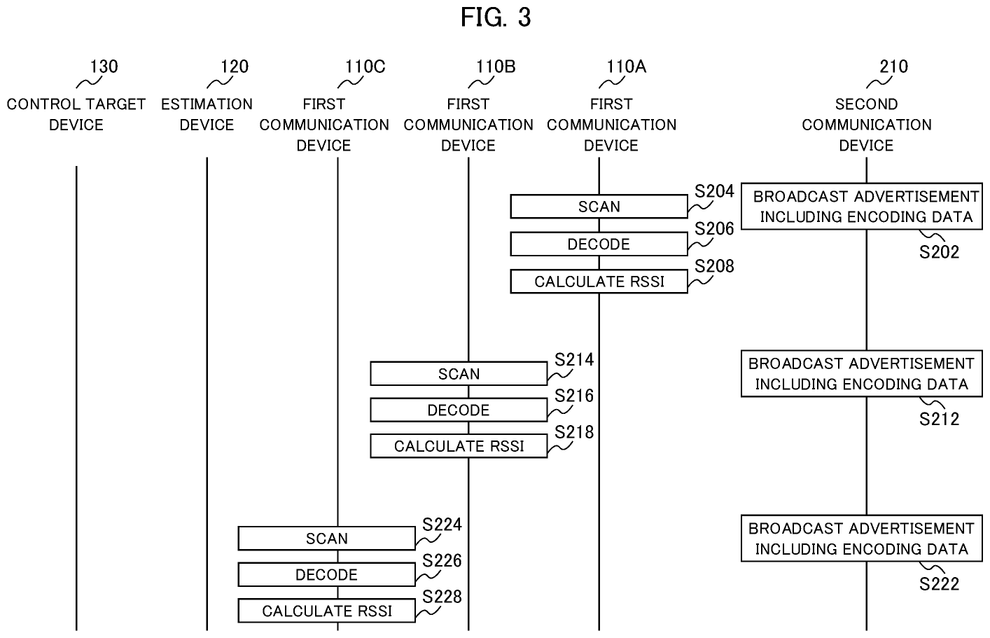

FIG. 3 is a sequence diagram illustrating an example of a flow of the acquisition of information that is used for the position estimation of the second communication device 210 according to the present embodiment.

In the example illustrated in FIG. 3, the second communication device 210 first broadcasts an advertisement including encoding data (S202).

The second communication device 210 may transmit an advertisement (ADV_IND) including, for example, a resolvable private address.

Next, the first communication device 110A scans the advertisement broadcast in step S202 (S204).

In addition, the first communication device 110A attempts to decode the encoding data included in the advertisement scanned in step S202 (S206).

The first communication device 110A may decode, for example, the resolvable private address included in the advertisement (ADV_IND) by using IRK.

In a case where it is possible to decode the encoding data in step S206, the first communication device 110A admits that the transmitter of the advertisement is a regular communication device and calculates, on the basis of the advertisement, information that is used for the position estimation of the second communication device 210 (S208).

In addition, the first communication device 110B also calculates information that is used for the position estimation of the second communication device 210 through steps 5212 to 5216 equal to steps 5202 to 5206 described above (S218).

Similarly, the first communication device 110C also calculates information that is used for the position estimation of the second communication device 210 through steps 5222 to 5226 equal to steps 5202 to 5206 described above (S228).

It should be noted that it is unnecessary to synchronize timings (S204, 5214, and 5224) at which the first communication devices 110A to 110C scan advertisements. In contrast, in a case where the timings at which the first communication devices 110A to 110C scan advertisements are synchronized, it may be possible to begin an estimation process earlier.

In addition, the information that is used for the position estimation of the second communication device 210 according to the present embodiment may be information calculated from the reception condition of an advertisement including encoding data.

For example, in the case of the example illustrated in FIG. 3, the first communication devices 110A to 110C each calculate the RSSI on the basis of the reception condition of an advertisement including encoding data that is decodable (S208, 5218, or S228).

The information that is used for the position estimation of the second communication device 210 according to the present embodiment is not, however, limited to RSSI.

For example, the information that is used for the position estimation of the second communication device 210 according to the present embodiment may be an estimated value (distance measurement value) of the distance between the first communication device 110 and the second communication device 210 or the like calculated from the reception condition of an advertisement including encoding data.

In addition, for example, the information that is used for the position estimation of the second communication device 210 according to the present embodiment may be AoA (Angle of Arrival), AoD (Angle of Departure), or the like obtained from the reception conditions of a plurality of advertisements.

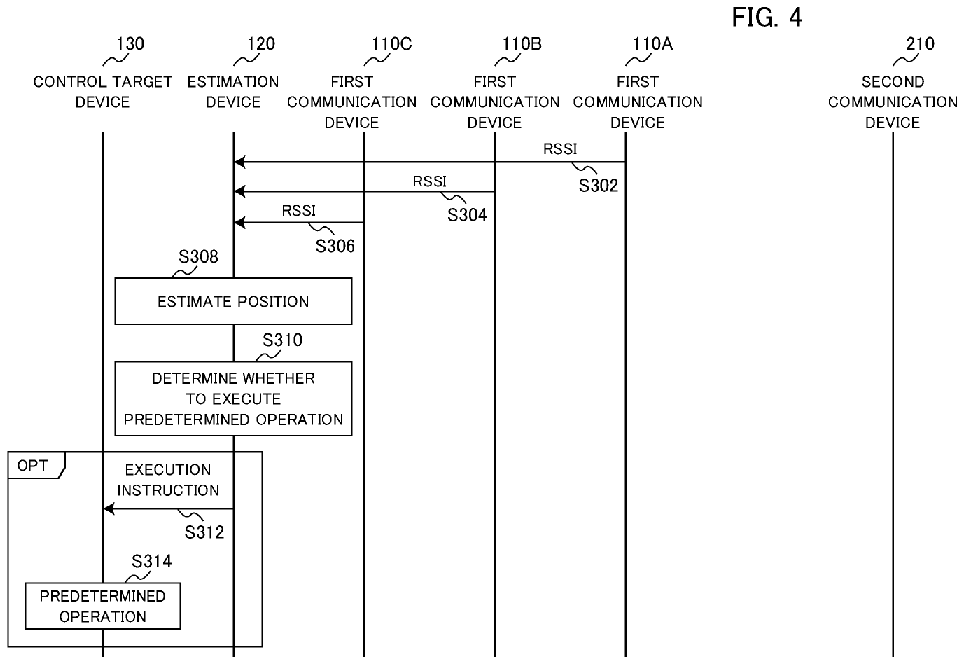

Subsequently, a flow of control over the control target device 130 based on the position estimation of the second communication device 210 according to the present embodiment and a result of the position estimation will be described with reference to FIG. 4 by using an example.

FIG. 4 is a sequence diagram illustrating an example of a flow of control over the control target device 130 based on the position estimation of the second communication device 210 according to the present embodiment and a result of the position estimation.

It should be noted that the sequence exemplified in FIG. 4 is performed after the sequence exemplified in FIG. 3.

In a case of the example illustrated in FIG. 4, the first communication device 110A transmits the RSSI calculated in step S208 illustrated in FIG. 3 to the estimation device 120 (S302).

In addition, the first communication device 110B transmits the RSSI calculated in step S218 illustrated in FIG. 3 to the estimation device 120 (S304).

Similarly, the first communication device 110C transmits the RSSI calculated in step S228 illustrated in FIG. 3 to the estimation device 120 (S306).

Next, the estimation section 125 included in the estimation device 120 estimates the position of the second communication device 210 on the basis of the respective RSSIs received in steps S302, S304, and S306 (S308).

In this case, the estimation section 125 may estimate the position of the second communication device 210 by using a technique based on RSSI and widely used in the position estimation field in addition to the technique disclosed in JP 2022-012634A.

In addition, the estimation section 125 may similarly adopt a technique widely used in the position estimation field in a case where the estimation section 125 uses a delay time, a distance measurement value, AoA, AoD, or the like in place of RSSI.

Next, the estimation section 125 determines whether to cause the control target device 130 to execute a predetermined operation (determines whether to execute a predetermined operation) on the basis of the position of the second communication device 210 estimated in step S308 and a result of the authentication in step S114 illustrated in FIG. 2 (S310).

For example, the estimation section 125 may determine that the control target device 130 is caused to execute the predetermined operation in a case where the estimation section 125 estimates in step S308 that the second communication device 210 is positioned within a predetermined range and the authentication in step S114 proves the authenticity of the portable apparatus 20.

In this case, the estimation section 125 transmits an execution instruction to the control target device 130 to instruct the control target device 130 to execute the predetermined operation (S312).

In addition, the control target device 130 executes the predetermined operation on the basis of the execution instruction received in step S312 (S314).

In contrast, the estimation section 125 may determine that the control target device 130 is not caused to execute the predetermined operation in a case where the estimation section 125 estimates in step S308 that the second communication device 210 is not positioned within the predetermined range or the authentication in step S114 does not prove the authenticity of the portable apparatus 20.

In this case, no execution instruction is transmitted in step S312 or the predetermined operation is not executed in 5314.

The flow of the control over the control target device 130 based on the position estimation of the second communication device 210 according to the present embodiment and a result of the position estimation has been described above.

The flows described above with reference to FIGS. 3 and 4 are, however, merely examples. It is possible to flexibly modify the flow of the control over the control target device 130 based on the position estimation of the second communication device 210 according to the present embodiment and a result of the position estimation.

For example, a case is conceived where the mobile body 10 is mounted with the plurality of first communication devices 110 and one (e.g., the first communication device 110A according to the present embodiment) of the plurality of first communication devices 110 authenticates the second communication device 210.

In this case, the first communication device 110 that authenticates the second communication device 210 does not necessarily have to calculate the RSSI of an advertisement including encoding data. The first communication device 110 that authenticates the second communication device 210 may calculate, for example, the RSSI of an authentication information request or an authentication information response and transmit the RSSI to the estimation device 120.

In addition, FIG. 3 has exemplified the case where the second communication device 210 broadcasts an advertisement and the first communication device 110 scans the advertisement.

In contrast, an advertisement including encoding data may be broadcast by the first communication device 110 and scanned by the second communication device 210.

In this case, the second communication device 210 may calculate the RSSI of the advertisement including the encoding data. The second communication device 210 may transmit the calculated RSSI to the estimation device 120 through the first communication device 110.

Further, the position estimation of the second communication device 210 may be performed by the control device 220 mounted on the portable apparatus 20. In this case, it is sufficient if the control device 220 performs the position estimation of the second communication device 210 on the basis of RSSI calculated by the first communication device 110 or the second communication device 210 and transmits a result of the position estimation to the estimation device 120 through the second communication device 210 and the first communication device 110.

As described above, it is possible to flexibly modify the flow of the control over the control target device 130 based on the position estimation of the second communication device 210 according to the present embodiment and a result of the position estimation.

### 2. Supplemental Information

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, the case where the first communication device 110, the estimation device 120, and the control target device 130 are mounted on the mobile body 10 has been described as a main example in the embodiment described above. The scope of the application of the estimation system 1 is not, however, limited to the example.

For example, the estimation system 1 may be used to perform control to lock or unlock a door installed in a house, an office building, or the like. In this case, the control target device 130 may be a locking and unlocking device that locks and unlocks the door described above. In addition, in this case, the control target device 130 and the first communication device 110 may be mounted on the door described above.

In addition, for example, the estimation system 1 may be used to perform control to lock or unlock a delivery box installed in each place. In this case, the control target device 130 may be a locking and unlocking device that locks and unlocks the delivery box described above. In addition, in this case, the control target device 130 and the first communication device 110 may be mounted on the delivery box.

In addition, for example, the estimation system 1 may be used to perform control to open and close an automatic ticket gate installed in the transportation facility. In this case, the control target device 130 may be a device that opens or closes the automatic ticket gate. In addition, in this case, the control target device 130 and the first communication device 110 may be mounted on the automatic ticket gate.

The estimation system 1 is widely applicable to a situation in which the execution of some processes is controlled on the basis of a result of the position estimation of the portable apparatus 20.

In addition, the series of processes by the respective devices described herein may be achieved by a non-transitory computer readable storage medium having programs stored therein. Each of the programs is read by RAM and executed by a processor such as CPU, for example, when executed by a computer. The storage medium described above may be, for example, a magnetic disk, an optical disc, a magneto-optical disk, a flash memory, or the like. In addition, the programs described above may be distributed, for example, through a network without using the storage medium.

What is claimed is:

1. An estimation device comprising
an estimation section configured to estimate a position of a second communication device on a basis of wireless communication between at least one first communication device and the second communication device, the wireless communication being compliant with a predetermined communication standard, wherein
the predetermined communication standard is a standard in which communication including at least two communication stages is performed, the at least two communication stages including a first stage and a second stage,
the first stage is a communication stage in which information for establishing the second stage is transmitted and received,
the second stage is a communication stage that allows for more secure communication than communication in the first stage, and
the estimation section estimates the position of the second communication device on a basis of a broadcast signal including encoding data, the broadcast signal being broadcast by one of the first communication device or the second communication device in the first stage.

2. The estimation device according to claim 1, wherein the estimation section estimates the position of the second communication device on a basis of information calculated from a reception condition of the broadcast signal including the encoding data that is decodable.

3. The estimation device according to claim 2, wherein the encoding data is encoded and decoded by using a key that is exchanged in a process of pairing the first communication device and the second communication device.

4. The estimation device according to claim 1, wherein the broadcast signal is a signal that is first to be transmitted and received in the first stage.

5. The estimation device according to claim 2, wherein the estimation section estimates the position of the second communication device on a basis of RSSI of the broadcast signal.

6. The estimation device according to claim 1, wherein the predetermined communication standard includes BLE.

7. The estimation device according to claim 1, wherein, in a case where the estimation section estimates that the second communication device is positioned within a predetermined range, the estimation section causes a control target device to execute a predetermined operation.

8. The estimation device according to claim 7, wherein the predetermined operation includes unlocking or locking.

9. The estimation device according to claim 1, wherein the estimation device is mounted on a mobile body.

10. A non-transitory computer readable storage medium having a program stored therein, the program causing a computer to achieve
an estimation function of estimating a position of a second communication device on a basis of wireless communication between at least one first communication device and the second communication device, the wireless communication being compliant with a predetermined communication standard, wherein
the predetermined communication standard is a standard in which communication including at least two communication stages is performed, the at least two communication stages including a first stage and a second stage,
the first stage is a communication stage in which information for establishing the second stage is transmitted and received,
the second stage is a communication stage that allows for more secure communication than communication in the first stage, and
the program causes the estimation function to estimate the position of the second communication device on a basis of a broadcast signal including encoding data, the broadcast signal being broadcast by one of the first communication device or the second communication device in the first stage.

11. An estimation system comprising:
at least one first communication device; and
an estimation device configured to estimate a position of a second communication device on a basis of wireless communication between the first communication device and the second communication device, the wireless communication being compliant with a predetermined communication standard, wherein
the predetermined communication standard is a standard in which communication including at least two communication stages is performed, the at least two communication stages including a first stage and a second stage,
the first stage is a communication stage in which information for establishing the second stage is transmitted and received,
the second stage is a communication stage that allows for more secure communication than communication in the first stage, and
the estimation device estimates the position of the second communication device on a basis of a broadcast signal including encoding data, the broadcast signal being broadcast by one of the first communication device or the second communication device in the first stage.
